(19) United States
(12) Patent Application Publication
(10) Pub. No.: US 2005/0194541 A1
(43) Pub. Date: Sep. 8, 2005

(54) Large area ionization detector and methods for detecting low level radiation

(76) Inventors: Brett M. Clark, Spokane, WA (US); Ronald H. Fleming, Spokane, WA (US)

Correspondence Address: WELLS ST. JOHN P.S., 601 W. FIRST AVENUE, SUITE 1300, SPOKANE, WA, 99201, US

(21) Appl. No.: 10/793,319

(22) Filed: Mar. 3, 2004

(51) Int. Cl. G01T 1/185

(52) U.S. Cl. 250/385.1

(57) ABSTRACT

The invention includes an ionizing radiation detector which includes a chamber within a housing. A receiving member within the chamber has a plurality of spaced holders for receiving samples. The samples are maintained in an array of substantially parallel samples with the samples functioning as electrodes within the chamber. The invention includes a method of counting emissions from samples. An odd number of electrodes are introduced into a detector chamber. Each of the electrodes includes at least one sample to be analyzed. The electrodes are organized into an array of substantially parallel electrodes, each electrode being in electrical communication with a contact surface. The electrode array includes cathodes and anodes where the number of cathodes differs from the number of anodes by one. A voltage is applied across the electrodes and particle emission is detected from the samples based upon ionization of counting gas within the chamber.

### TECHNICAL FIELD

The invention pertains to ionizing radiation detectors and methods of measuring emissions from samples.

### BACKGROUND OF THE INVENTION

The purity of materials utilized in the electronic industry for applications such as semiconductor device fabrication is known to effect operation of the devices. As the dimensions of semiconductor devices are reduced to allow for higher density and lower power, sensitivity to ionizing radiation increases. For example, alpha particle emission from impurities in a material utilized in semiconductor fabrication can affect internal data states causing “soft” errors. The rate at which soft errors occur can be referred to as the “soft error rate” and is affected by the rate of alpha particle emission which is based upon material purity.

As high-purity low-alpha materials are developed and produced, it is important to assess and monitor the material purity to determine suitability of the material for its intended purpose. It is also important to be able to monitor or assess alpha particle emission rates during and/or after semiconductor wafer fabrication. Current gas proportional counting instrumentation for monitoring alpha emission has limited sensitivity due to detector area constraints (typically less than 3600 cm²) and significant background counts. Additionally, measurement times for low-alpha materials utilizing conventional instrumentation can be on the order of weeks or months to achieve acceptable precision.

It is desirable to develop instrumentation and methodology having improved emission detection capability.

### SUMMARY OF THE INVENTION

In one aspect the invention encompasses an ionizing radiation detector which includes a measurement chamber within a vacuum chamber. A receiving member within the measurement chamber has a plurality of spaced holders for receiving a plurality of samples. The samples are maintained in an array of substantially parallel samples with at least some of the samples functioning as electrodes within the chamber.

In one aspect the invention encompasses a method of counting emissions from a plurality of samples. An odd number of electrodes are introduced into a measurement chamber which has a plurality of contact surfaces. Samples (electrodes) are organized into an array of substantially parallel electrodes, each electrode being in electrical communication with a contact surface. The electrode array includes cathodes and anodes where the number of cathodes differs from the number of anodes by one. A voltage is applied across the electrodes and particle emission is detected from the samples based upon ionization of a counting gas within the chamber. Because both the anode electrodes and cathode electrodes comprises samples, the active detector area can be determined by the number and geometry of the samples.

### BRIEF DESCRIPTION OF THE DRAWINGS

Preferred embodiments of the invention are described below with reference to the following accompanying drawings.

FIG. 1 is a diagrammatic cross-sectional side view of instrumentation in accordance with one aspect of the invention.

FIG. 2 is a diagrammatic cross-sectional side view of a portion of a detection chamber and an exemplary array in accordance with one aspect of the invention.

FIG. 3 is a cross-sectional top view of a chamber in accordance with an aspect of the invention and illustrating the exemplary array shown in FIG. 2.

FIG. 4 is a cross-sectional side view illustration of a portion of a detector and electrode array in accordance with an alternative aspect of the invention.

FIG. 5 is a cross-sectional top view of the detector and electrode array depicted in FIG. 4.

FIG. 6 is a diagrammatic cross-sectional side view of instrumentation with an alternative electrode array configuration from that shown in FIG. 1.

FIG. 7 is a cross-sectional top view of a detector with an alternative electrode array configuration relative to that depicted in FIGS. 4 and 5.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

In general, emission of alpha particles from materials can be measured by placing the material or a sample of interest comprising the material into a counting chamber, applying a voltage between a cathode and an anode or anode grid and detecting gas ionization caused by alpha particle emission. In conventional systems, the cathode can typically be either a thin conductive mylar window or sometimes the sample to be monitored. Anode materials can be, for example, small diameter wire. As the particle passes through the gas it produces electron-ion pairs which accelerate through the voltage, collect on corresponding electrodes and produce an electric current flow or voltage pulse. The pulse can be amplified and processed.

For high purity materials and samples of interest having low emission, factors such as background, measured sample area and sample positioning can affect signal detection and instrument sensitivity. One aspect of the invention is to develop methodology and instrumentation to allow increased sensitivity and ability to accurately detect or monitor alpha emissions and reduced counting time requirement. This may be accomplished by increased detector area, decreased background, increased efficiency or combinations thereof.

The methodology and instrumentation of the invention can be particularly useful for analyzing high purity materials and for applications such as semiconductor fabrication where high purity materials are particularly desirable. Although aspects of the invention are described with reference to alpha particle emission and alpha particle detectors, it is to be understood that the methodology and instrumentation design can be adapted for utilization in detection of other types of radiation.

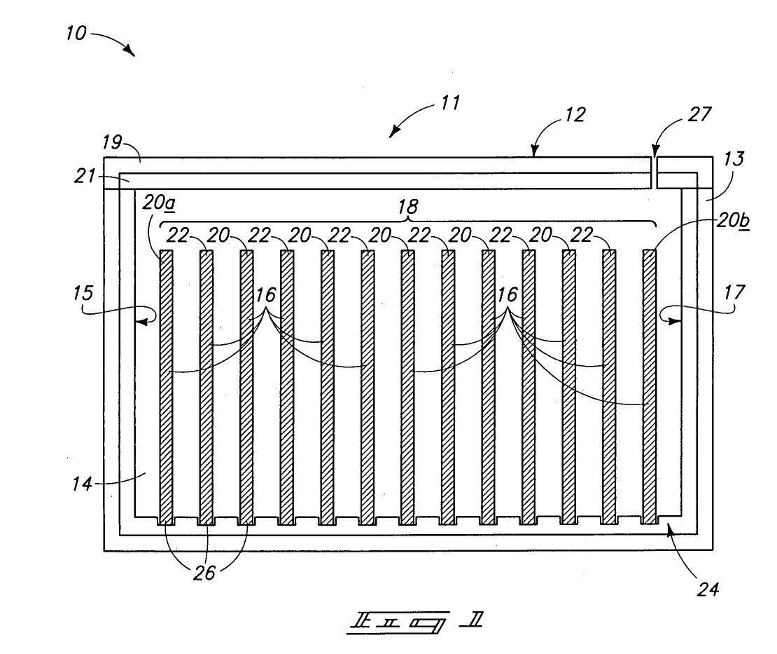

A first aspect of the invention is described with reference to FIGS. 1-3. Referring initially to FIG. 1, such diagrammatically illustrates exemplary instrumentation and configuration thereof. Detection instrumentation 10 can include a detector 11 having a vacuum chamber 12. Vacuum chamber 12 can have a housing 13 which can be around an internal measurement chamber 14. Housing 13 can comprise an electrically conductive material which is preferably connected to ground. This housing configuration can shield measurement chamber 14 from external electronic noise. Vacuum chamber 12 can have a rectangular or box shape as shown in FIG. 1, or can have an alternative shape such as, for example, a cylindrical shape (not shown). It can be advantageous to provide vacuum chamber 12 with a rectangular shape to allow maximal use of the internal area of internal chamber 14 without limiting sample shape.

A plurality of conductive samples 16 can be introduced within chamber 14 and be configured into a sample array 18. Samples 16 are not limited to any particular shape and can be, for example, square, rectangular or circular. In particular applications, samples 16 can be substantially planar and array 18 can be referred to as an array of substantially planar samples. In one embodiment of the invention, samples 16 can be individual semiconductor wafers.

In one embodiment of the invention where a plurality of semiconductor wafers is to be analyzed, measurement chamber 14 can have an appropriate interior space area of up to about 6300 cm³. Appropriate chamber dimensions can be, for example, up to approximately 30 cm×30 cm×70 cm. This dimension can be utilized, for example, for measuring emission from a plurality of 300 mm semiconductor wafers. Measurement of emission from alternative sized wafers is also contemplated.

It is to be understood that alternative samples and sample sizes can be utilized and the dimensions of measurement chamber 14 can be adapted or scaled relative to the number and size of samples 16 that are to be simultaneously analyzed. Where an array of 13 individual samples make up an array 18 such as depicted in FIG. 1, the internal chamber size of 30 cm×30 cm×70 cm can be preferred. Vacuum chamber 12 can be configured to have external dimensions appropriate for the number of samples 16 to be simultaneously measured and the internal volume of chamber 14. Accordingly vacuum chamber 12 can have external dimensions of up to about 30 inches in length, 14 inches width and about 15 inches height. However, the invention encompasses utilization of as few as three individual samples to make up an array 18 (not shown) and dimensions of measurement chamber 14 and the external dimensions of the detector can be scaled accordingly. It is to be understood that the invention encompasses utilization of a measurement chamber at less than the maximum sample capacity.

Sample array 18 can be an array of electrodes where samples 16 are utilized as cathodes 20 and anodes 22. Array 18 can preferably comprise an odd number of electrodes 16, and can preferably be configured such that a first electrode 20ₐ adjacent a first chamber wall 15 operates at ground potential and a last electrode 20_{b} disposed adjacent an opposing chamber wall 17 also functions at ground potential. Array 18 is also preferably configured such that every second electrode 20 operates at ground potential. Accordingly, in operation, an absence of voltage potential between detector walls 13 and the corresponding adjacent outermost electrode 20ₐ, 20_{b} results in an absence of ion and electron acceleration between the chamber walls and the outermost electrodes. This configuration shields the active detector area from alpha particle emission from chamber wall construction materials and can thereby reduce or minimize alpha background relative to less preferred configurations.

Because samples 16 serve as the anodes and cathodes, the detector active area can be defined by the samples themselves. As indicated above, measurements can be conducted at less than the maximum sample capacity of the measurement chamber. Where less than the maximum number of samples is utilized, the resulting empty space does not contribute toward the signal or background. The minimum number of samples is three. The increase in active area relative to conventional devices can achieve a significant increase in signal level. Further, the variable active area can allow a significant improvement and flexibility relative to conventional fixed-area devices. The variable active area can allow shorter analysis time by providing increased active area for the number of samples available. For example, a low activity material can be measured in about ten days utilizing the three sample configuration, or in one day utilizing a thirteen sample configuration.

Since walls 24 of internal measurement chamber 14 are in close proximity to the sensitive detector region, walls 24 can preferably comprise insulative material having low or minimal alpha emission. Insulative materials appropriate for use in accordance with the invention include but are not limited to insulators with low radioactivity such as polyimide (e.g. KAPTON®; E. I. du Pont de Nemours and Company, Wilmington, Del.), polycarbonate (e.g. PLEXIGLASS® Rohm and Haas Company, Philadelphia, Pa.) polytetrafluoroethylene (e.g. TEFLON®; E. I. du Pont de Nemours and Company, Wilmington, Del.), polypropylene, or any other low radioactivity insulator with dielectric properties suitable for the present invention.

Measurement chamber 14 can be a removable chamber or can be alternatively configured to be retained within vacuum chamber 12. Vacuum chamber 12 can be constructed to have a housing lid portion 19 which can be disposed on a top portion of chamber 12 as shown in FIG. 1. Alternatively, lid 19 can be comprised by a side or bottom portion of vacuum chamber 12 (not shown). Similarly, measurement chamber 14 can be configured to comprise a lid 21 over a top portion of chamber 14 as shown, or can be alternatively configured as appropriate for the configuration of vacuum chamber 12. Measurement chamber 14 can preferably be isolated from vacuum chamber 12 by placing a vibration dampening material, such as VITON® (E. I. du Pont de Nemours and Company, Wilmington, Del.,) for example, between the interfacing surfaces of the chambers (not shown).

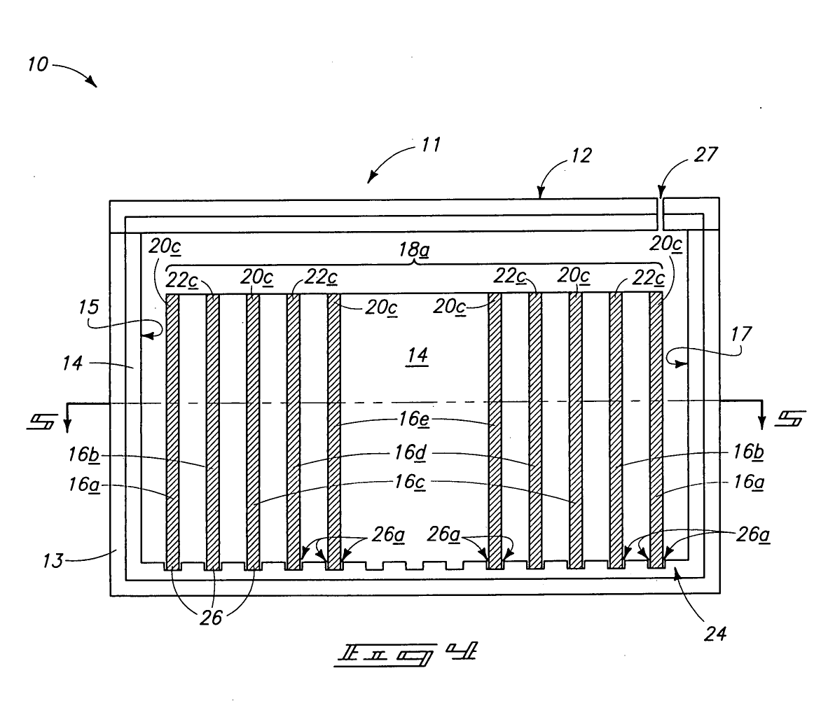

Holders 26 can be provided within measurement chamber 14 in receiving relation relative to samples 16. An exemplary configuration for holders 26 is shown in FIG. 1 where holders 26 are slots or grooves integral within chamber walls 24. In such configuration, a portion of insulative material 24 comprising the holders can be referred to as a receiving member. Where holders 26 are slots within chamber walls 24, such slots are preferably provided at least within a bottom portion of chamber 14. Slots 26 can also be provided along one or more wall portions of housing 24 (depicted in FIG. 3 and discussed below).

It is to be understood that the invention contemplates utilization of alternative integral or non-integral holders appropriate for holding wafers or other samples within chamber 24 (not shown). Alternative holders can comprise for example, support members or arms which can protrude from a floor surface and/or wall surface of the measurement chamber. Where support members or arms are utilized, such can preferably be of sufficient length to isolate samples (such as wafer samples) from any alpha radiation emanating from chamber walls.

Referring again to FIG. 1, holders 26 are preferably configured to hold planar samples 16 to be substantially parallel to chamber wall surfaces 15 and 17 and substantially parallel relative to each other. Additionally, the holders are preferably configured to minimize or prevent sample movement and/or vibration. Although FIG. 1 shows electrode array 18 as being an array of vertical electrodes, it is to be understood that the depicted configuration is a preferred array and that the invention contemplates utilization of a horizontal electrode array (not shown). Accordingly, vacuum chamber 12, measurement chamber 14 and holders 26, can be modified for adaptation to a horizontal array.

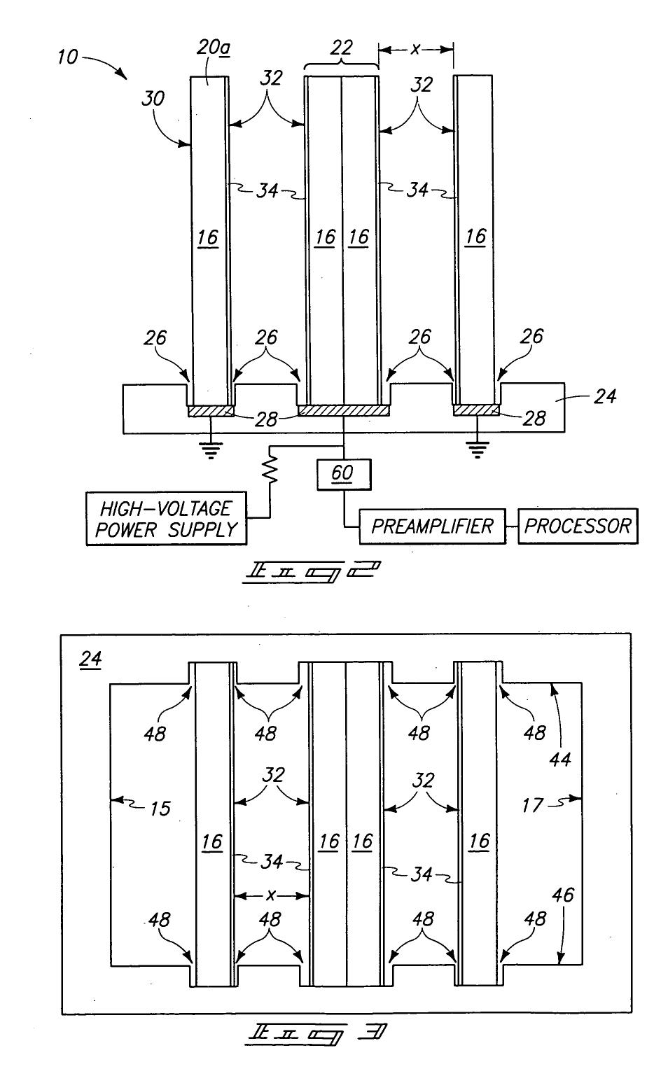

Particular aspects of the present invention are described in more detail with reference to FIG. 2. FIG. 2 illustrates an exemplary array 18 having three electrodes 20 and 22. First and last electrodes 20 are shown as received by holders 26 within insulative wall material 24. Wall material 24 can be provided to have a plurality of contact surfaces 28. When holders 26 are slots, contact surfaces 28 can be disposed at a base surface of slots 26 such that electrodes 20 and 22 received within slots 26 are in electrical communication with contact surfaces 28. As shown, the outermost electrodes 20 are connected to ground and can function as cathodes during operation of detector instrumentation 10. Where array 18 consists of three electrodes, a central electrode 22 can be connected to a voltage source and can function as an anode during detector operation.

Samples 16 which are utilized as electrodes can also serve as detectors during device operation. As noted above, the outermost electrodes in an array which are disposed nearest the chamber walls preferably serve as cathodes, both the outermost electrodes being connected to ground. Accordingly, a surface of the outermost electrodes which faces the chamber walls will not contribute toward the detected signal.

As illustrated in FIG. 2, samples 16 can have a backside 30 and an opposing front side 32 where a material of interest 34 from which alpha particle emission is to be analyzed is disposed at or near front surfaces 32. Accordingly, when samples 16 are received within holders 26 it can be preferable to utilize a single sample 16 as the two outermost electrodes with back surfaces 30 facing outwardly toward the corresponding adjacent walls. However, electrodes disposed between the outermost cathode electrodes 20 can comprise two samples as shown in FIG. 2. Although FIG. 2 shows a single electrode 22 between the outermost electrodes, it is to be understood that the invention encompasses utilization of multiple 2-sample electrodes disposed between the outermost electrodes of array 18. Accordingly, referring back to FIG. 1, each of the intervening electrodes disposed between electrode 20ₐ and electrode 20_{b} can consist of a single sample as depicted, or alternatively can contain two samples. It is to be understood that the invention encompasses any combination of single sample and double sample electrodes.

The width of slots 26 can be configured according to the thickness of samples 16 and the number of samples to be received within each slot. Slots configured to hold a single wafer sample can have an appropriate slot with of, for example, about 2 mm.

Referring again to FIG. 2, where two samples 16 are comprised by a single electrode 22, the two samples can preferably be received in a back to back configuration with backsides 30 of the samples positioned at an interface between the two samples with each of the opposing front surfaces 32 facing outwardly relative to the interface. In a preferred configuration of electrode array 18, front surfaces 32 of samples of adjacent electrodes can be separated by a distance “x” where x is from about 4 cm to about 5 cm. The electrode spacing can be adjusted depending upon the range of alpha particles of the expected energy in the counting gas.

In aspects of the invention where electrode array 18 has single samples utilized for outer electrodes 20ₐ and 20_{b}, and two samples for each of the intervening electrodes a maximum number of individual samples received within chamber 14 can preferably be 24. Accordingly, the sample surface contributing toward the alpha emission signal can be up to 24 times higher that the sample area contributing toward a signal in a conventional single sample detector.

Referring again to FIG. 1, detector 12 can preferably be configured for utilization as a gas-filled detector. Accordingly, one or more passages 27 can be provided for introducing and/or exhausting an ionization gas from vacuum chamber 12. Ionization gases which can be utilized within chamber 12 include P-10 (where P-10 refers to a gas which comprises about 90% argon and about 10% methane), or other appropriate ionization gases currently known by those skilled in the art or yet to be developed.

Detector 11 can preferably be configured to operate as an ionization counter (at relatively low electric field). However, it is to be understood that the invention also encompasses embodiments where device 11 is configured to operate at an increased electrical field for use as a gas proportional counter.

With reference to FIG. 2, detector 11 can be configured such that individual anode 22 is in electrical communication with a high-voltage power supply via a resistor, and in electrical communication with detector electronics via a capacitor 60. In larger arrays, individual anodes can be in electrical communication with individual capacitors 60 such that the number of capacitors 60 is equivalent to the number of anodes within array 18 (not shown). Alternatively, two or more anodes can be in electrical communication with mutual capacitor-resistor pairs or the entire set of anodes in array 18, regardless of number, can be in electrical communication with a single capacitor (not shown). Anodes 22 can also be in electrical communication with a pre-amplifier and processor, such as a digital pulse processor. The described configuration can be advantageous relative to conventional detection systems since such can provide anti-coincidence capability and thereby better distinguish between signal and noise.

Cathodes 20a and 20b (and any additional cathodes comprised by an electrode array in accordance with the invention) can be in direct electrical communication with the ground of the detector electronics as shown in FIG. 2.

Although FIG. 1 illustrates array 18 as having 13 electrodes and FIG. 2 illustrates array 18 as having 3 electrodes, it is to be understood that the invention encompasses utilization of any odd number of electrodes. An exemplary array can have, for example, less than or equal to 13 electrodes with a preferred number of electrodes being an odd number from 3 to 13 (i.e., 3, 5, 7, 9, 11 or 13).

Referring to FIG. 3, such shows a top view of measurement chamber 14 configured to receive the three electrode/four sample array depicted in FIG. 2. As shown, wall portions of insulative material 24 can be slotted for receiving the electrodes/samples and can hold or assist in holding the samples in the desired configuration. Preferably, the electrodes are configured to be substantially parallel relative to chamber wall surfaces 15 and 17. It is to be understood however that the invention encompasses providing chamber wall surfaces lacking wall slots 48. Additionally, alternative holders or stabilizers can be provided such as previously described.

Methodology for detecting alpha emission from samples utilizing a detection system in accordance with FIGS. 1-3 of the invention is described. For purposes of the present description, samples of interest can be semiconductor wafers. It is to be understood that although the description is set forth utilizing semiconductor wafers, the invention encompasses utilization of alternative sample types.

Detection of alpha emission from wafers can be performed at any stage of wafer fabrication. Devices and methodology of the invention can be particularly useful for monitoring alpha particle emission after deposition of one or more materials which can potentially contain alpha emitting contaminants. Exemplary materials include, but are not limited to, materials comprising lead, tin titanium, aluminum, and/or copper. Contaminants within these materials can include, but are not limited to, thorium, uranium, and daughters thereof.

Due to the low penetrability of alpha particles through solids, it can be desirable that a potentially alpha emitting material 34 (FIG. 2) be within about 20 microns of front surface 32 of the wafer at the time of alpha emission detection measurements.

Detector background contribution can be determined in an absence of material 34. In order to increase or maximize accuracy of background determinations, it can be preferable that the device be operated utilizing an equivalent number of samples that will be utilized during non-background analysis, with the background samples being treated similarly to the samples of interest but which lack material 34. Alternatively, background can be measured by placing a conducting material with zero alpha emission in the detector and measuring alpha emission from the measurement chamber.

A plurality of semiconductor wafers 16 can be introduced into a detector chamber 14 such as that illustrated in FIG. 1. The plurality of samples can function as electrodes and thereby serve as both samples and detectors during measurement of alpha particle emissions. The samples can be configured to form electrode array 18 comprising substantially parallel electrodes 20, 22 such that each electrode is in electrical communication with a contact surface 28 (FIG. 2). Contact surfaces 28 can be disposed at a base surface within grooves 26 which are provided within an insulative material 24. Array 18 preferably contains an odd number of electrodes numbering less than or equal to 13. Preferably, the array of electrodes contains 3, 5, 7, 9 or 11 electrodes.

The wafer samples can be received within chamber 14 such that each of the electrodes 20, 22 contains a single semiconductor wafer. Alternatively, the two external electrodes 20ₐ and 20_{b} can each contain a single semiconductor wafer, and intervening electrodes can each include two semiconductor wafers disposed back to back as shown in FIG. 2. Electrode array 18 preferably comprises a number of cathodes which exceeds the number of anodes by one.

Alternatively described, semiconductor wafers are preferably received within chamber 12 such that an electrode array is established where the number of electrodes equals n, where n is an odd number of at least 3 and as large as desired for the application. The electrodes can be referred to as being numbered in series from 1 to n, with the first and n^{th} electrodes being correspondingly disposed adjacent opposing walls 15 and 17 of chamber 14. Odd numbered electrodes of the series preferably function as cathodes and even numbered electrodes preferably function as anodes.

An ionizing gas can be provided within chamber 14 through inlet 27. A voltage can be applied across the electrodes and particle emission from the semiconductor wafers can be detected and/or counted based upon ionization within the chamber. In a preferred aspect, air within chamber 14 can be removed prior to introduction of the counting gas. Such removal can utilize, for example, a vacuum pump (not shown).

Methodology of the invention can advantageously provide increased signal to noise ratio relative to conventional detectors due to decreased background and increased sampling area. The methodology of the present invention can allow background to be reduced below the 3-5 alphas/hr background typical in convention detectors. In particular aspects, methodology and instrumentation of the invention can allow background of less than about 1 count per hour. Additionally, the sample area of the described instrumentation is well above the 1000 cm² sample area typical of conventional detectors. Accordingly, measurement time can be significantly reduced relative to conventional methodology and detector configuration. This can in turn allow increased emission detection and monitoring ability for high purity materials, semiconductor wafers and other electronic devices. Accordingly, precise sample measurement of less than 0.002 alphas/hr/cm² can be obtained in less than one week.

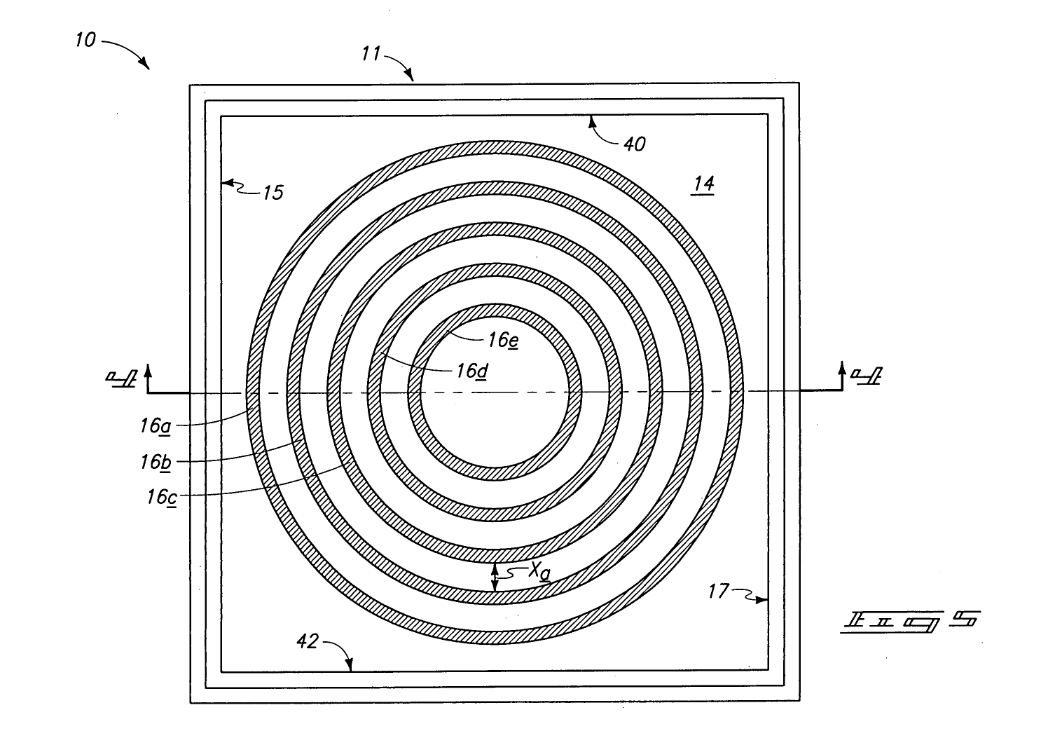

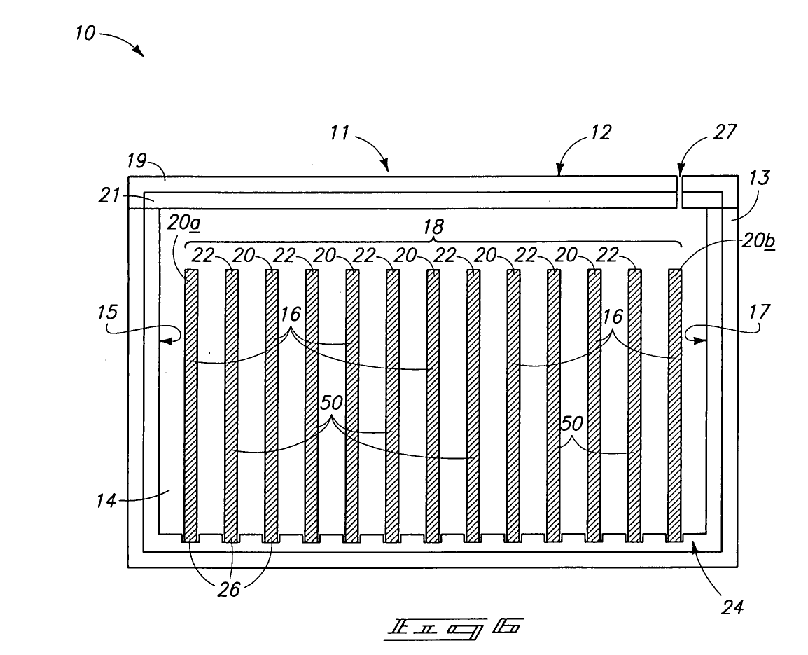

A second aspect of the invention is described generally with reference to FIGS. 4 and 5. An instrumentation system 10 having many features in common with aspects of the invention described with reference to FIGS. 1-3 is depicted. Features in common with the earlier figures are numbered identically. Features that are modified or new are assigned a corresponding subscripted identifier or a unique newly assigned identifier.

With reference to FIG. 4, such shows an electrode array 18 comprising a plurality of electrodes 16ₐ through 16ₑ. Electrodes 16ₐ through 16ₑ can comprise a sample of interest. Each of samples 16ₐ, 16_{b}, 16_{c}, 16_{d} and 16ₑ can have a cylindrical shape. Such can be more clearly seen as depicted in FIG. 5 which shows a top view of chamber 14 containing the electrode array 18ₐ. As shown in FIG. 5, electrode array 18ₐ can comprise a plurality of spaced electrodes configured such that array 18ₐ is a concentric electrode array. Although FIGS. 4 and 5 show a five electrode array, it is to be understood that the invention contemplates utilization of alternative number of cylindrical electrodes. The number of electrodes in array 18ₐ can be greater than or equal to two. Array 18ₐ and instrumentation 10 can preferably be configured such that sample ring or cylinder 16ₐ disposed nearest the wall surfaces 15, 17, 40 and 42 of chamber 14 functions as a cathode during detector operation. Where the number of electrodes is odd, the centermost sample will also serve as a cathode. Accordingly, the area of chamber 14 that is within cylinder 16e and the area of chamber 14 external to cylinder 16a does not contribute to alpha particle detection signal. It can be advantageous to provide a cylindrical array having the external and internal samples serving as electrodes to minimize background noise as described above for the planar array. Cylindrical samples can further decrease background due to the absence of background contribution by chamber construction materials around the sample edges such as can occur in an alternative array.

As shown in FIGS. 4 and 5, the cylinders within array 18a are preferably substantially vertical. Insulative liner material 24 can be provided to have ring shaped grooves 26ₐ for receiving the cylindrical samples. Contact surfaces can be provided within slots 26ₐ in a manner analogous to that discussed above with reference to FIGS. 1-3. Array 18ₐ can preferably be configured such that each of rings 16ₐ, 16_{b}, 16_{c}, 16_{d} and 16ₑ are spaced apart from adjacent cylinders by a distance xₐ which measures from at least about 4 cm to about 5 cm. Electrode spacing can be adjusted depending upon the range of alpha particles of the expected energy in the counting gas.

Instrumentation 10 can be configured and fabricated for chamber 14 to have an appropriate size for the desired number of samples to make up array 18ₐ. Similarly, external device dimensions can be scaled accordingly with internal and external dimensions similar to those discussed above with respect to FIGS. 1-3.

Methodology for utilization in conjunction with the aspect of the invention illustrated in FIGS. 4 and 5 can include formation of cylindrical samples to be received within chamber 14. Cylinders 16a through 16e (or fewer or greater number of cylinders) can be formed of appropriate size for being received with slots 26a. Materials of interest for analysis accordingly to methodology of the invention can include materials to be utilized for fabrication of electronic devices or semiconductor wafer fabrication. Exemplary materials of interest can be for example, solders, materials to be deposited by physical vapor deposition or chemical vapor deposition, or materials derived or deposited from these materials. Such materials can comprise, for example, one or more of lead, titanium, aluminum, copper, tin or other materials which are known to potentially contain alpha emitting contaminants. Such contaminants can include, for example, thorium, uranium and/or daughters thereof.

Once the samples of interest have been formed into cylindrical shapes of the appropriate size, the samples can be received within chamber 14 to form a concentric array of cylindrical electrodes. Counting gas can be provided within chamber 14 through inlet 27. A voltage can be applied across the electrodes and particle emissions can be detected from the samples based upon ionization events within the chamber. As with the aspects described earlier, samples 16ₐ through 16ₑ can serve as detectors as well as samples during detector operation. Additionally, the detector can be configured for utilization as an ionization chamber or as a gas proportional counter as described above.

It can be advantageous to utilize a plurality of samples as electrodes and detectors in an array of concentric electrodes as described with reference to FIGS. 4 and 5 to provide an increased surface area contribution to signal relative to single-sample detectors. Additionally, it can be advantageous to configure a concentric sample array such that an outer sample is connected to ground to reduce noise contribution of detector walls. The described methodology and detector configuration can accordingly provide increased signal to noise ratio and can achieve emission measurement over a decreased amount of measurement time relative to conventional detector methodology.

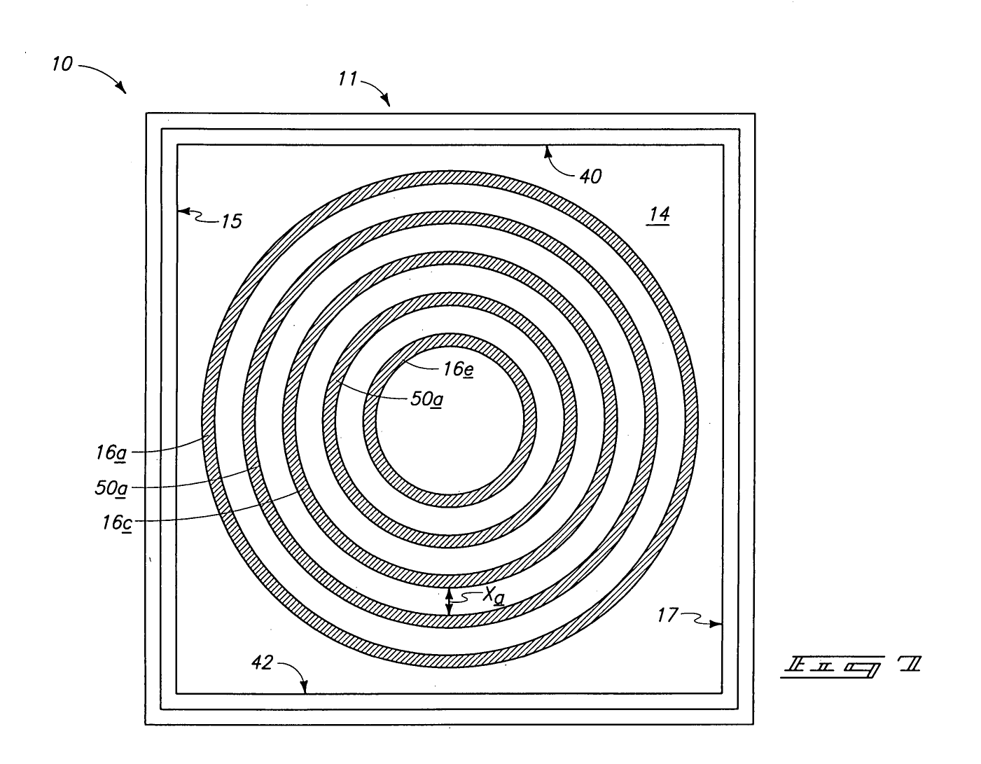

Additional alternative detector configurations are discussed with reference to FIGS. 6-7. Referring to FIG. 6, such shows a detector configuration similar to that depicted in FIG. 1. However, the anodes 22 of device 12 shown in FIG. 6 do not comprise samples. Anodes 22 of FIG. 6 can comprise an alternative electrode material 50, such as a wire grid or other conventional electrode material. It is to be understood that the number of electrodes and other variables discussed with respect to FIGS. 1-3 apply equally to the alternative aspect shown in FIG. 6.

When anodes 22 comprise non-sample material 50, the surface area contributing to the signal is reduced accordingly. However, the use of multiple samples as cathodes in conjunction with conventional anodes can retain reduced noise and increased signal relative to conventional detectors.

Referring to FIG. 7, such shows the described alternative anode material aspect described above as applied to concentric electrode array 18a. One or more cylindrical anode 22a can comprise a non-sample electrode 50a. Electrodes 50a can comprise, for example, a cylindrical wire grid or alternative conventional electrode material. The number of electrodes and other variable discussed with respect to the aspects shown in FIGS. 4-5 can apply equally to the exemplary instrumentation shown in FIG. 6.

In aspects of the invention where the electrode array comprises conventional non-sample anodes such as wire or wire grid anodes, counter 11 can be preferably operated as a gas proportional counter. However, it is to be understood that the invention contemplates configurations of detection system 10 for either ionization counting or gas proportional counting regardless of the specific electrode array utilized.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A radiation detector comprising:
a housing;
a measurement chamber within the housing;
a receiving member within the measurement chamber, the receiving member having a plurality of spaced holders for receiving a plurality of samples such that the plurality of samples is maintained in an array of substantially parallel samples, at least some of the plurality of samples functioning as electrodes within the chamber.

2. The radiation detector of claim 1 wherein the plurality of holders consists of an odd number of holders.

3. The radiation detector of claim 1 wherein the receiving member comprises a wall portion of the measuring chamber, the wall portion comprising an insulative material, wherein the holders comprise slots within the insulative material, and wherein the array of substantially parallel samples are disposed vertically within the chamber.

4. The radiation detector of claim 3 wherein the insulative material comprises at least one material selected from the group consisting of polyimide, polycarbonate, polytetrafluoroethylene, and polypropylene.

5. The radiation detector of claim 1 wherein the receiving member comprises a floor surface of the chamber.

6. The radiation detector of claim 1 wherein the plurality of holders comprises a first holder, a last holder, and a central holder disposed centrally between the first and last holders.

7. The radiation detector of claim 6 wherein the first holder and the last holder are each configured to hold at least one sample, and wherein the central holder is configured to hold two samples.

8. The radiation detector of claim 7 wherein samples disposed in the first holder and the last holder serve as cathodes.

9. The radiation detector of claim 8 wherein samples disposed within the central holder function as a cathode.

10. The radiation detector of claim 8 wherein samples disposed within the central holder function as an anode.

11. The radiation detector of claim 8 wherein the plurality of holders further comprises at least one additional holder between the first holder and the central holder and at least one additional holder between the central holder and the last holder, and wherein samples disposed in a holder adjacent the first holder serve as an anode, and wherein samples disposed in a holder adjacent the last holder serve as an anode.

12. An alpha emission counter comprising an array of substantially parallel electrodes, the array including an odd number of electrodes, at least two of the electrodes comprising samples of interest.

13. The counter of claim 12 wherein the counter is a gas-filled proportional counter.

14. The counter of claim 12 wherein the counter is a gas-filled ionization chamber detector.

15. An alpha emission detector comprising:
an array of concentric electrodes, the array including an odd number of electrodes, at least two of the electrodes being samples of interest, an inner most and an outermost of the electrodes operating at ground potential.

16. The counter of claim 15 wherein the counter is a gas-filled proportional counter.

17. The counter of claim 15 wherein the counter is a gas-filled ion chamber detector.

18. The counter of claim 15 wherein each of the electrodes is spaced from each adjacent electrode by a distance of from about 4 cm to about 5 cm.

19. An ionization detector comprising:
a detection chamber; and
a slotted surface within the detection chamber, the slotted surface comprising a plurality of slots configured for receiving samples, the slots including a first slot through a n^{th} slot, where n is an odd number, the detector being configured such that samples received in the plurality of slots function as electrodes during a detection cycle.

20. The ionization detector of claim 19 wherein the first slot and the n^{th} slot are each configured to receive a single sample and wherein at least some of the slots disposed between the first slot and the n^{th} slot are configured to receive two samples.

21. The detector of claim 19 wherein samples received within the odd numbered slots function as cathodes during detection and samples received within even numbered slots function as anodes during detection.

22. The detector of claim 21 wherein the slots are circular and the samples are cylindrical.

23. The detector of claim 21 wherein the slots are linear and the samples are substantially planar.

24. The detector of claim 23 wherein the samples are semiconductor wafers.

25. A method of counting emissions from a plurality of samples, comprising:
providing a detector chamber having a plurality of contact surfaces;
introducing an odd number of electrodes into the detector chamber, each of the electrodes comprising at least one sample to be analyzed;
configuring an array of substantially parallel electrodes from the odd number of electrodes, each electrode being in electrical communication with a contact surface comprised by the plurality of contact surfaces, a first number of the electrodes being anode electrodes and a second number of electrodes being cathode electrodes, the first number and differing from the second number by one;
applying a voltage across the electrodes; and
detecting particle emission from the samples based upon counting-gas ionization within the chamber.

26. The method of claim 25 wherein the chamber comprising a first wall and an opposing second wall, wherein the electrodes are disposed substantially parallel to the first wall and the second wall and wherein an electrode disposed nearest the first wall functions as a cathode, and wherein an electrode disposed nearest the second wall functions as a cathode.

27. The method of claim 26 wherein the electrode disposed nearest the first wall comprises a single sample, wherein the electrode disposed nearest the second wall comprises a single sample, and wherein a set of electrodes is disposed between the electrode disposed nearest the first wall and the electrode disposed nearest the second wall, each electrode of the set comprising two samples.

28. The method of claim 27 wherein the samples are semiconductor wafers having a front surface and a back surface, and wherein the electrodes comprising two samples have the two samples disposed back surface to back surface.

29. The method of claim 25: wherein the detector chamber is an ionization chamber.

30. A method of counting emissions from a plurality of samples, comprising:
providing a detector chamber having a plurality of concentric circular receiving grooves;
introducing a cylindrical electrode into each of the concentric receiving grooves, at least two of the electrodes comprising samples to be analyzed;
providing an ionization gas within the chamber;
applying a voltage across the electrodes; and
detecting particle emission from the samples based upon ionization within the chamber.

31. The method of claim 30 wherein the receiving grooves are disposed within an insulative chamber liner comprising at least one member selected from the group consisting of the liner comprises at least one insulative material selected from the group consisting of polyimide, polycarbonate, polytetrafluoroethylene, and polypropylene.

32. The method of claim 30 wherein the samples comprise at least one of lead, aluminum, copper, titanium and tin.

33. The method of claim 30 wherein the samples comprises at least one member of the group consisting of a solder material, a physical vapor deposition material, a chemical vapor deposition material, a soldered material, a physical vapor deposited material or a chemical vapor deposited material.

34. A method of detecting alpha emission from a semiconductor wafer, comprising:
providing a plurality of semiconductor wafers having a front surface and a back surface, each of the semiconductor wafers comprising a material within about 20 μm from the front surface;
utilizing the plurality of semiconductor wafers as electrodes within a detector chamber; and
detecting emission of alpha particles from the material.

35. The method of claim 34 wherein the chamber comprises:
a wall surface;
a first electrode adjacent and spaced from the wall surface;
a second electrode disposed adjacent and spaced from the first electrode; and
a third electrode disposed adjacent and spaced from the second electrode, the first, second and third electrodes being substantially parallel to the first wall surface, and the wall surface, the first electrode and the third electrode each being connected to ground.

36. The method of claim 35 wherein the first electrode contains a single semiconductor wafer and wherein the second electrode comprises two semiconductor wafers disposed: back to back relative to each other.

37. The method of claim 35 wherein the chamber further comprises:
a fourth electrode disposed adjacent and spaced from the third electrode; and
a fifth electrode disposed adjacent and spaced from the fourth electrode, the fifth electrode being connected to ground.

38. The method of claim 37 wherein the third and fourth electrodes each comprises two wafers disposed back to back relative to each other.

39. The method of claim 35 wherein the electrodes are spaced from each other by a gap of from about 4 cm to about 5 cm.

40. The method of claim 35 wherein the anode electrodes each comprise a wire grid and wherein the cathode electrodes each comprises at least one semiconductor wafer.
